(19) United States
(12) Patent Application Publication
(10) Pub. No.: US 2009/0079830 A1
(43) Pub. Date: Mar. 26, 2009

(54) Robust framework for enhancing navigation, surveillance, tele-presence and interactivity

(76) Inventor: Frank Edughom Ekpar, Aizuwakamatsu City (JP)

Correspondence Address: FRANK EDUGHOM EKPAR, Matsunaga 1-17-26- A-107, Ikki-Machi, Aizuwakamatsu City, 965-0001, JP

(21) Appl. No.: 12/220,550

(22) Filed: Jul. 28, 2008

Related U.S. Application Data
(60) Provisional application No. 60/962,407, filed on Jul. 27, 2007.

(51) Int. Cl. H04N 5/00

(52) U.S. Cl. 348/148; 348/E05.001

(57) ABSTRACT

The present invention discloses a robust framework for enhancing navigation, surveillance, tele-presence and interactivity via media streams. A primary media stream acquisition unit is disposed to capture an input media stream (for example video stream) representing the environment and transmit captured media stream live or archived to a transform unit providing means of transforming captured media stream to a desired format and applying appropriate distortion correction measures such that said media stream becomes more suitable for further processing. The transformed media stream is fed to an analysis unit implementing means of analyzing transformed media stream for the detection and tracking of objects or other desired results. Adaptive refinement of the accuracy of analysis results permits improvements in the performance of the analysis unit with increasing use. A rendering unit displays views of the primary media stream and an optional secondary media stream captured by an optional secondary media acquisition unit under the control of input from a control unit and/or overlay unit. The overlay unit provides means of overlaying detected/tracked objects of interest on a map of the environment represented by the media stream and means of using events occurring at or near the locations of said overlaid objects on said map to control the view of the environment presented to the user. View control via events affecting overlaid objects could be achieved through the simultaneous control of the transformed view of the primary media stream and of a secondary media acquisition unit disposed to capture a higher resolution view of the indicated region of the environment. A control unit receives user input that is used to determine what combinations of views to display from the primary and/or secondary media streams. Control signals from the control unit could also be used to control other units in the system including the transform, analysis and overlay units.

### CROSS-REFERENCE TO RELATED APPLICATIONS

This U.S. Non-Provisional Application claims the benefit of U.S. Provisional Application Ser. No. 60/962,407, file on Jul. 27, 2007, herein incorporated by reference.

### BACKGROUND OF THE INVENTION

1. Field of the Invention

The present invention relates generally to the fields of media stream navigation, surveillance, tele-presence and interactivity. In particular, the invention relates to a robust framework for enhancing navigation, surveillance, tele-presence and interactivity via media streams.

2. Description of the Prior Art

In systems designed to improve information navigation, surveillance and tele-presence, it is advantageous to use a media stream acquisition device capable of acquiring real-time visual information from a wide angle of view. Accordingly, systems capable of acquiring 360-degree views of the environment in real time are preferred. For the effective capture of a seamless 360-degree view of a scene, wide-angle imaging systems are required to satisfy the constraint of possessing a unique effective viewpoint. Some of the most cost-effective contemporary systems for acquiring real-time wide-angle visual media streams are so-called catadioptric and mirror-based panoramic imaging systems capable of capturing a complete 360-degree view of the environment in a single image frame. U.S. Pat. Nos. 6,341,044 and 6,130,783 describe two such systems. The limited resolution of state-of-the-art digital video capture devices that are often used in conjunction with catadioptric and mirror-based panoramic imaging systems to capture wide angle media streams makes the use of systems that are much more expensive and difficult to maintain a viable alternative in a limited number of applications. One such alternative is the use of a multiple camera system in which the individual cameras are arranged in a way that permits the system to capture a complete 360-degree field of view. After calibration and alignment of the individual, usually overlapping, image segments captured by the cameras, image-stitching algorithms are used to compose a substantially seamless 360-degree panoramic mosaic. Such systems are constrained by the high cost, relatively large size and maintenance requirements of the complex multiple camera arrangement. Results similar to those obtained using the multiple camera arrangement can also be obtained by rotating a single camera system around a fixed point, capturing overlapping segments of the scene as the system is rotated. The difficulties associated with this approach limit the use of such systems to relatively static environments and applications not requiring real-time 360-degree image capture. Although catadioptric and mirror-based panoramic imaging systems offer significant advantages over alternatives, they often exhibit substantial distortion in the images they produce. This distortion needs to be corrected in other to render the images in a form more suitable for human viewing.

Researchers and practitioners have disclosed several applications of panoramic imaging systems to the problems of remote surveillance, enhancement of vehicle navigation and related areas. For example, in U.S. patent Publication Number 20030071891, Geng, Z. Jason describes an intelligent surveillance system providing a means of capturing and analyzing an omni-directional or panoramic image with the goal of identifying objects or events of interest on which a higher-resolution (pan-tilt-zoom or PTZ) camera—can be trained. Although the method and apparatus disclosed by Geng compensates for the relatively limited resolution of the panoramic images by analyzing objects and events of interest and then training a higher-resolution PTZ camera on the region of the scene indicated by the objects/events of interest, it makes no further use of the objects/events detected as a means of enhancing navigation and/or situational awareness. In U.S. Pat. No. 6,693,518, Kumata, et al. disclose a surround surveillance system comprising an omni-azimuth (360-degree panoramic) visual system mounted on a mobile body such as a car. The '518 patent permits the display of a global panoramic and/or more restricted perspective-corrected view of the surroundings of the mobile body on a display capable of switching between said panoramic and/or perspective view and a Global Positioning System (GPS)-enabled location map on which the location of the mobile body itself can also be displayed. Although the system described in the '518 patent is limited to mobile bodies, it provides greater situational awareness since it indicates the position of the mobile body housing the panoramic imaging system. However, the '518 patent provides no means of using events and/or objects of interest on the map to control the view displayed by the system. Since the panoramic imaging system provides a wide field of view, the display of objects and/or events visible to the panoramic imaging system on the GPS-enabled map would provide a dramatic improvement in situational awareness for the user of the system. Additionally, the use of non-visual sensors such as 3D audio sensors, range sensors or any other sensors capable of generating signals that could be analyzed for the detection and location of objects/events and the overlay of such detected objects/events on the GPS-enabled or any other suitable local/global map of the surroundings of the system would provide for vastly improved navigation, surveillance, tele-presence and interactivity.

### SUMMARY OF THE INVENTION

It is an object of the present invention to overcome the limitations of the prior art set forth above by providing a robust framework for enhancing navigation, surveillance, tele-presence and interactivity via media streams.

### BRIEF DESCRIPTION OF THE DRAWINGS

FIG. 1 illustrates the preferred embodiment of the present invention.

### DETAILED DESCRIPTION OF THE PREFERRED EMBODIMENTS

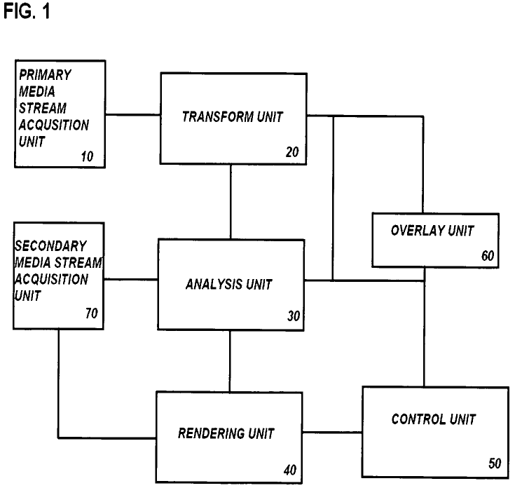

Referring now to FIG. 1, an illustration of the preferred embodiment of the present invention, a primary media stream acquisition unit, 10, is disposed to capture an input media stream representing the environment. The media stream could comprise video, audio, range signals or any combination of these and/or any other useful signals. Visual information could be 2-dimensional, stereoscopic, holographic, etc, and signals could be in the visible, infrared or any other suitable spectrum. For the capture of visual signals, the unit preferably comprises a 360-degree panoramic imaging system with no moving parts such as that described in U.S. Pat. No. 6,341,044 in combination with a suitable visual signal detector such as a CCD camera or infrared camera for night vision. Audio can be captured by an integrated or separate array of microphones, preferably providing a means of locating audio sources in 3-dimensional space. Suitable range sensors could be used to capture range signals. The signals acquired by the primary media stream acquisition unit, 10, can be archived for further processing and/or transmission later or transmitted to the transform unit, 20.

The transform unit, 20, provides means of transforming the media stream into any desired format for further processing. Suppose the input stream is panoramic video captured using the combination of a video camera and a catadioptric panoramic imaging system permitting a seamless 360-degree field of view. The transform unit, 20, in this case could implement a method of correcting distortions in the panoramic image stream and presenting a transformed, distortion-free media stream for further processing. A robust and practical system for the correction of distortions in images is described in U.S. patent application Ser. No. 10/728,609. Another robust distortion correction method based on constructive neural networks is disclosed in U.S. Pat. No. 6,671,400. The transform unit, 20, also provides any required mapping between the coordinate system of the device capturing the media stream and the coordinate system of the map contained in the overlay unit, 60. Use of transform unit, 20, enables the system to use a very wide range of primary and secondary acquisition systems.

The transformed media stream is fed to the analysis unit, 30, implementing means of analyzing the transformed media stream for the detection and tracking of objects/events or other desired results. The rendering unit, 40, displays views of the primary media stream and an optional secondary media stream captured by an optional secondary media acquisition unit, 70, under the control of input from a control unit, 50, and/or overlay unit, 60. The rendering unit, 40, could be a computer monitor, head-up display, head-mounted unit or any other suitable display surface. The overlay unit, 60, provides means of overlaying detected/tracked objects/events of interest on a map of the environment represented by the media stream and means of using events occurring at or near the locations of said overlaid objects on said map to control the view of the environment presented to the user. The map could be a 2D or 3D image map of the region. The map could also be implemented as a suitable physical surface (e.g. planar, spherical, cylindrical, etc) adapted to contain static and/or dynamic information (including position and orientation information) about the scene contained in the primary and/or secondary media streams and could also be adapted to allow the overlay of information indicating the locations and orientations of objects/events of interest and means (such as a point-and-click or movable scanning device) capable of providing location and orientation information about regions of interest on the map. The use of such a physical surface provides a novel and intuitive means of interaction and control. Alternatively, a dynamic global map of the region updated via Global Position System (GPS) or similar positioning system could be used as a map. Objects of interest (detected/tracked/recognized) in the media stream are rendered as an overlay on a map of the environment captured by the media acquisition unit. This allows a clear and immediate indication of how objects of interest are positioned relative to other features of the captured environment. Approaches to the detection, tracking and identification of moving and stationary targets in a media stream are well known. Popular state-of-the-art approaches include temporal differencing using multiple frames, background subtraction and optical flow analysis. Adapatations of these well known methods that are amenable to real-time operation are also well described in the scientific literature. Neural networks capable of learning from input data and/or creating useful classifications by analyzing the media streams could also be used for robust object detection, tracking, identification and classification. According to the principles of the present invention, the results of the analysis units are adaptively refined to permit the unit to learn from previous mistakes and thus improve performance with increasing use. By allowing the map with overlaid objects of interest to act as an input surface, the map can be used to control what parts of the captured data is rendered. The high level of interactivity facilitated by this feature leads to enhanced navigation and situational awareness. Additionally, the use of non-visual sensors such as 3D audio sensors, range sensors or any other sensors capable of generating signals that could be analyzed for the detection and location of objects/events and the overlay of such detected objects/events on the GPS-enabled or any other suitable local/global map of the surroundings of the system would provide for vastly improved navigation, surveillance, tele-presence and interactivity. When a 2D or 3D image map rendered on a computer display is used as an overlay surface, mouse clicks could be used to indicate the positions of overlaid objects of on the map. The system allows simultaneous display of a detailed view of the region indicated by any selected object on the map and a higher resolution view of the region captured by secondary acquisition system in response to control signals generated via the selection of said object on map. View control via events affecting overlaid objects could be achieved through the simultaneous control of the transformed view of the primary media stream and of a secondary media acquisition unit disposed to capture a higher resolution view of the indicated region of the environment.

Given that the map would generally provide a straightforward way to match real-world object positions and distances with positions and distances on the map, a significant problem that needs to be resolved for the proper operation of the overlay unit, 60, is how to map distances and positions on the media stream captured by the media acquisition unit to the corresponding real-world distances and positions and thus to the corresponding distances and positions on the map. In the preferred embodiment of the present invention in which a catadioptric panoramic imaging system is used to capture visual information, the center of the donut-shaped 360-degree panoramic image can be taken to be the center of the visual scene and distances and positions in the donut-shaped image are related to the corresponding real-world distances and positions by their corresponding lateral angles (0 to 360 degrees) and vertical angles or azimuth (between the angle below and the angle above the horizon for the specific imaging system). Distances from the optical axis of the lens can be determined for arrangements that allow for the capture of 3-dimensional or range information. The orientations of objects can be established by selecting a ray from the center of the image representing the “true north” or other identifiable reference direction.

In the absence of 3-dimensional or range information, it is still possible to determine the 3-dimensional positions and distances of objects to an acceptable degree of accuracy. Although existing methods that rely on pre-existing knowledge of the characteristics of the scene exist, the present invention teaches a novel approach that is robust and capable of producing acceptably accurate results in a relatively simple manner. First, the stream acquisition unit is used to capture a set of calibration patterns with objects at known 3-dimensional positions. For visual information using a catadioptric 360-degree panoramic imaging system and a conventional video camera, the calibration patterns could comprise a set of white cylinders of varying radii with a set of black dots and lines of known 3-dimensional positions painted on the inner surfaces. The imaging system is placed in such a way that its optical center corresponds to the center of the cylinder and its optical axis is parallel to the axis of the cylinder. The 3-dimensional positions of the dots and their corresponding positions on the images captured by the imaging system are then recorded. The two sets of data (real-world 3-dimensional positions—obtained from calibration patterns—on one hand and the corresponding 2-dimensional positions—obtained from the corresponding 2-dimensional donut-shaped images—on the other hand) are then used as input-output data sets in the training of a suitably complex neural network. The trained neural network then represents a model of the mapping of real-world 3-dimensional positions to their corresponding 2-dimensional positions by the panoramic imaging system and can thus be used to estimate 3-dimensional position information from 2-dimensional position information to a desired degree of accuracy. Starting with a minimal neural network, a suitably complex constructive neural could automatically be constructed solely on the basis of the calibration data used to train the neural network. The robust techniques described here or more suitable techniques can be applied to other acquisition unit configurations.

The control unit, 50, receives user input that is used to determine what combinations of views to display from the primary and/or secondary media streams. Control signals from the control unit, 50, could also be used to control other units in the system including the transform, analysis and overlay units.

It should be understood that numerous alternative embodiments and equivalents of the invention described herein may be employed in practicing the invention and that such alternative embodiments and equivalents fall within the scope of the present invention.

What is claimed is:

1. A method and apparatus for enhancing navigation, interactivity, surveillance and tele-presence via media streams comprising an acquisition unit for acquiring, storing and transmitting media streams; a transform unit for applying transformations on and correcting distortions in media stream; an analysis unit for analyzing transformed media stream, detecting and classifying objects and events of interest in media stream, incorporating an adaptive means of learning from previous analysis mistakes with a view to providing more accurate analysis with increasing use and generating actionable data and commands; an overlay unit providing means of overlaying detected/tracked objects/events of interest on a map of the environment represented by the media stream and means of using events occurring at or near the locations of said overlaid objects/events on said map to control the view of the environment presented to the user and/or other aspects of the systems; a rendering unit for displaying views of the media stream and a control unit for user input and the control of the components of the system.

2. The method and apparatus of claim 1 wherein said acquisition unit comprises a primary acquisition unit for general-purpose media stream capture and a secondary acquisition unit for specialized media capture.

3. The method and apparatus of claim 1 wherein said acquisition unit is disposed to capture a substantially 360-degree view of the environment.

4. The method and apparatus of claim 1 wherein said view control via events affecting objects overlaid on the overlay unit is achieved through the simultaneous control of the transformed view of the primary media stream and of a secondary media acquisition unit disposed to capture a higher resolution view of the indicated region of the environment.
